(19) United States
(12) Patent Application Publication
(10) Pub. No.: US 2014/0165014 A1
(43) Pub. Date: Jun. 12, 2014

(54) TOUCH DEVICE AND CONTROL METHOD THEREOF

(71) Applicant: HON HAI PRECISION INDUSTRY CO., LTD., New Taipei (TW)

(72) Inventor: CHUN-HUNG SHEN, New Taipei (TW)

(73) Assignee: HON HAI PRECISION INDUSTRY CO., LTD., New Taipei (TW)

(21) Appl. No.: 14/098,603

(22) Filed: Dec. 6, 2013

(30) Foreign Application Priority Data
Dec. 10, 2012 (TW) 101146331

(51) Int. Cl. G06F 3/0488; G06F 3/041

(52) U.S. Cl. CPC G06F 3/04886; G06F 3/041
USPC 715/863; 345/173

(57) ABSTRACT

A touch device includes a touch display screen, a detection device, and a main control unit. The touch display screen displays an operation interface including at least one shortcut mark and executes a corresponding function when the at least one shortcut mark is operated on. The detection device detects whether the touch device is held by a left hand, a right hand, or both hands of a user in a landscape orientation and a portrait orientation, and outputs detecting signals based on the detection of the detecting device. The main control unit adjusts a display location of the at least one shortcut mark based on the detecting signals.

### BACKGROUND

1. Technical Field

The present disclosure relates to a touch device and a control method thereof.

2. Description of Related Art

FIGS. 1a-1b are schematic operation interfaces of a conventional touch device 1. The touch device 1 can be a smart phone, a tablet computer, or the like. For example, when a user of the touch device 1 needs to answer a call, the user may need to operate a slide bar X displayed at a bottom of a display screen to answer the call. However, it is inconvenient for the user to operate the slide bar X of FIG. 1a with the left hand, and it is inconvenient for the user to operate the slide bar X of FIG. 1b with the right hand.

Therefore, what is needed is a touch device and a control method that can overcome the described limitations.

### BRIEF DESCRIPTION OF THE DRAWINGS

FIG. 1a-1b are schematic operation interfaces of a conventional touch device.

FIG. 2 is a front view of one embodiment of a touch device.

FIG. 3 is a rear view of the touch device of FIG. 2.

FIG. 4 is a schematic block diagram of an embodiment of functional units of the touch device of FIG. 2.

FIGS. 5A-5F are operation interfaces of the touch device of FIG. 2.

FIGS. 6-7 are schematic views illustrating locations of first-fifth contact detection units and an orientation detection unit of FIG. 4.

FIG. 8 is a flowchart of an embodiment of a control method illustrating operation of the touch device of FIG. 2.

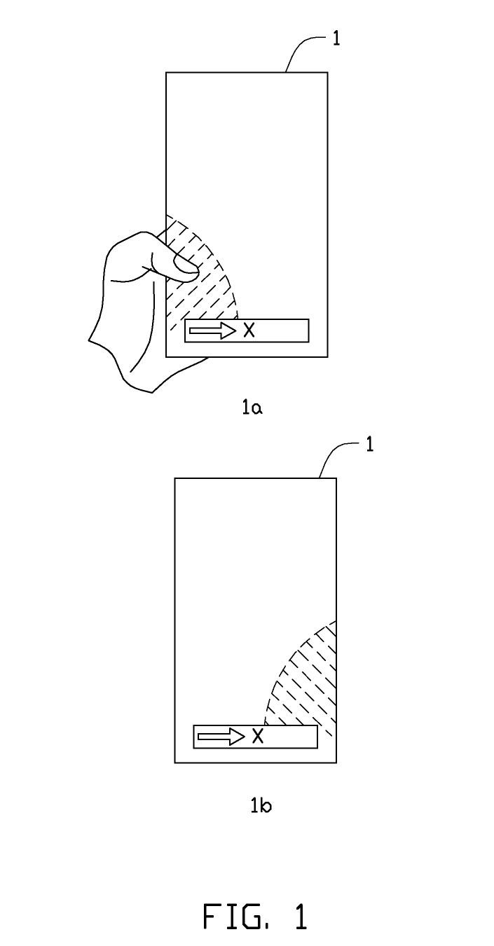

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

Reference will now be made to the drawings to describe embodiments of the present disclosure.

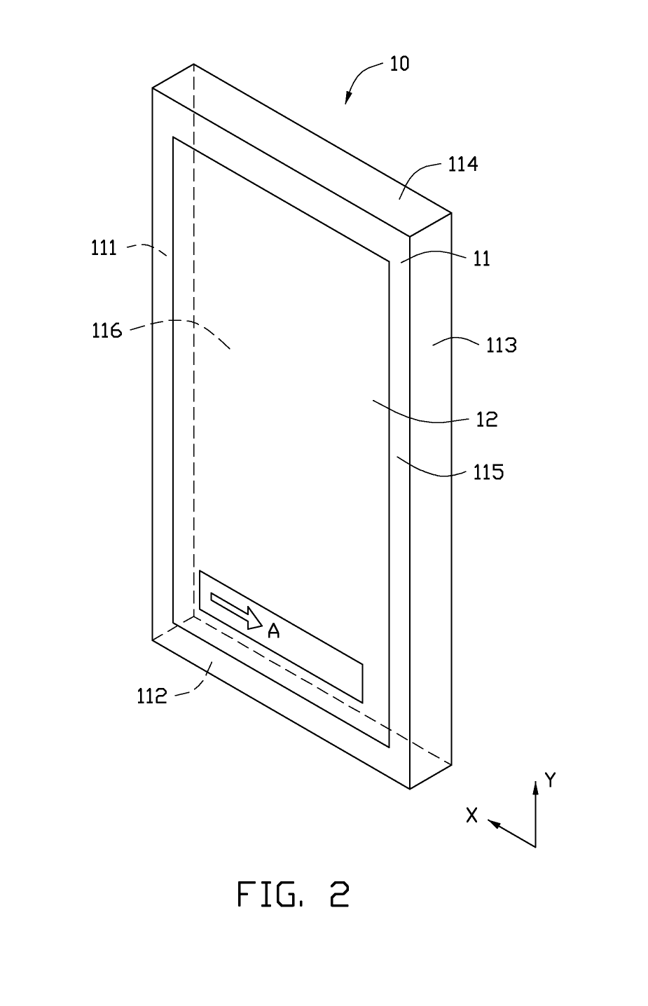

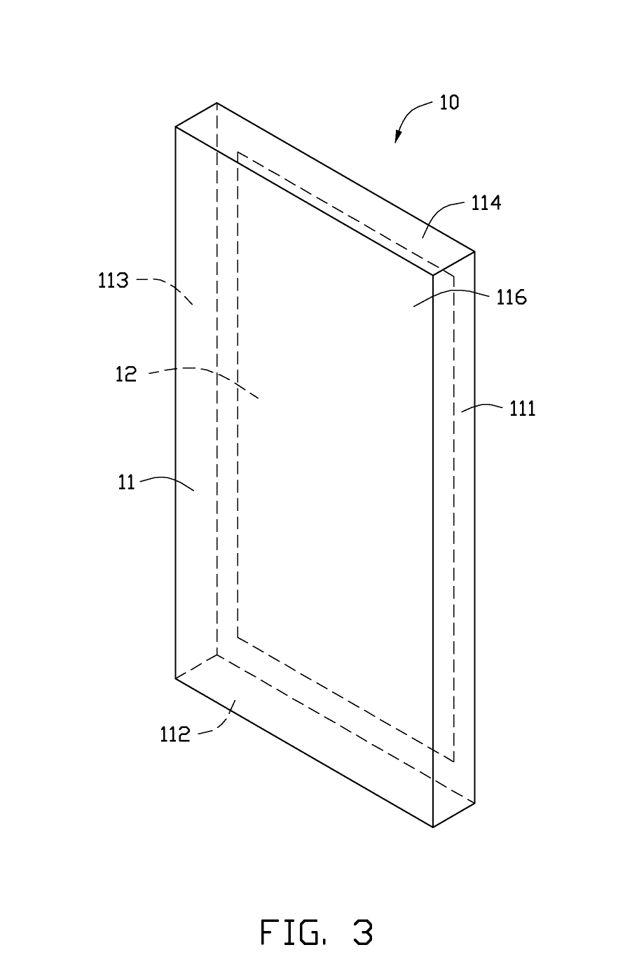

FIGS. 2-3 illustrate one embodiment of a touch device 10. The touch device 10 comprises an enclosure 11 and a touch display screen 12. The enclosure 11 is substantially cuboid and comprises a first side surface 111, a second side surface 112, a third side surface 113, a fourth side surface 114, a front surface 115, and a rear surface 116. The first, second, third, and fourth side surfaces 111, 112, 113, 114 are connected to one another end-to-end. The first side surface 111 faces the third side surface 113. The second side surface 112 faces the fourth side surface 114. A length of the first side surface 111 is substantially equal to a length of the third side surface 113. A length of the second side surface 112 is substantially equal to a length of the fourth side surface 114.

The lengths of the first and third side surfaces 111, 113 are longer than the lengths of the second and fourth side surfaces 112, 114. The rear surface 116 faces the front surface 115. The touch display screen 12 is received in the front surface 115.

The touch display screen 12 displays graphics, receives contact operations from a user, and executes corresponding functions based on the received contact operations. The touch display screen 12 displays an operation interface (not labeled). The operation interface comprises at least one shortcut mark A. When the at least one shortcut mark A is operated on, the touch device 10 executes a corresponding function. In one embodiment, the at least one shortcut mark A is a slide bar.

FIG. 2 shows a direction X substantially parallel to the second and fourth side surfaces 112, 114, and a direction Y substantially parallel to the first and third side surfaces 111, 113. When the first and third side surfaces 111, 113 are parallel to the X direction, the touch device 10 is in a landscape orientation. When the first and third side surfaces 111, 113 are parallel to the Y direction, the touch device 10 is in a portrait orientation. Gravity can be in −Y direction.

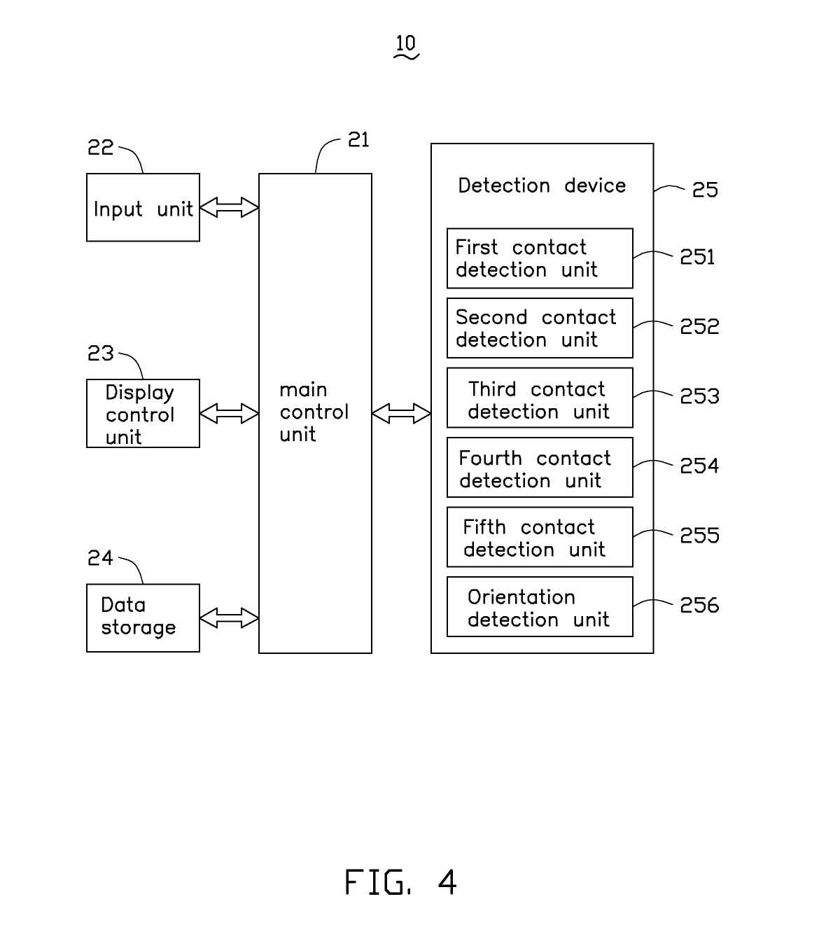

FIG. 4 is a schematic block diagram of the touch device 10. The touch device 10 further comprises a main control unit 21, an input unit 22, a display control unit 23, a data storage 24, and a detection device 25. The main control unit 21 communicates with the input unit 22, the display control unit 23, the data storage 24, and the detection device 25 via data buses (not labeled).

The main control unit 21 controls the touch device 10 to display graphics, play video, communicate with other devices, and outputs control signals to the input unit 22, the display control unit 23, the data storage 24, and the detection device 25. The input unit 22, the display control unit 23, the data storage 24, and the detection device 25 operate based on the control signals. In one embodiment, the main control unit 21 is a central processing unit (CPU).

The input unit 22 determines locations of the touch display screen 12 that are touched and outputs corresponding sensing signals to the main control unit 21.

The display control unit 23 outputs image data to the touch display screen 12 based on the control signals. The touch display screen 12 displays images based on the image data.

The main control unit 21 generates information (hereinafter “holding information”) based on how the touch device 10 is held by the user. In one embodiment, the holding information comprises first information, which indicates whether the touch device 10 is held in the landscape orientation or the portrait orientation, and second information, which indicates whether the touch device 10 is held by a right hand, a left hand, or both the right and left hands. In the embodiment, the detection device 25 comprises a first contact detection unit 251, a second contact detection unit 252, a third contact detection unit 253, a fourth contact detection unit 254, a fifth contact detection unit 255, and an orientation detection unit 256. The first through fifth contact detection units 251-255 and the orientation detection unit 256 detect whether the touch device 10 is held by the left hand, the right hand, or both hands in the landscape orientation and the portrait orientation, and output detecting signals to the main control unit 21.

The data storage 24 stores first corresponding relations between the detecting signals outputted from the detection device 25 and the holding information. The data storage 24 further stores second corresponding relations between the holding information and display locations of the at least one shortcut mark A. The data storage 24 can be an EPROM, EEPROM, or Flash ROM.

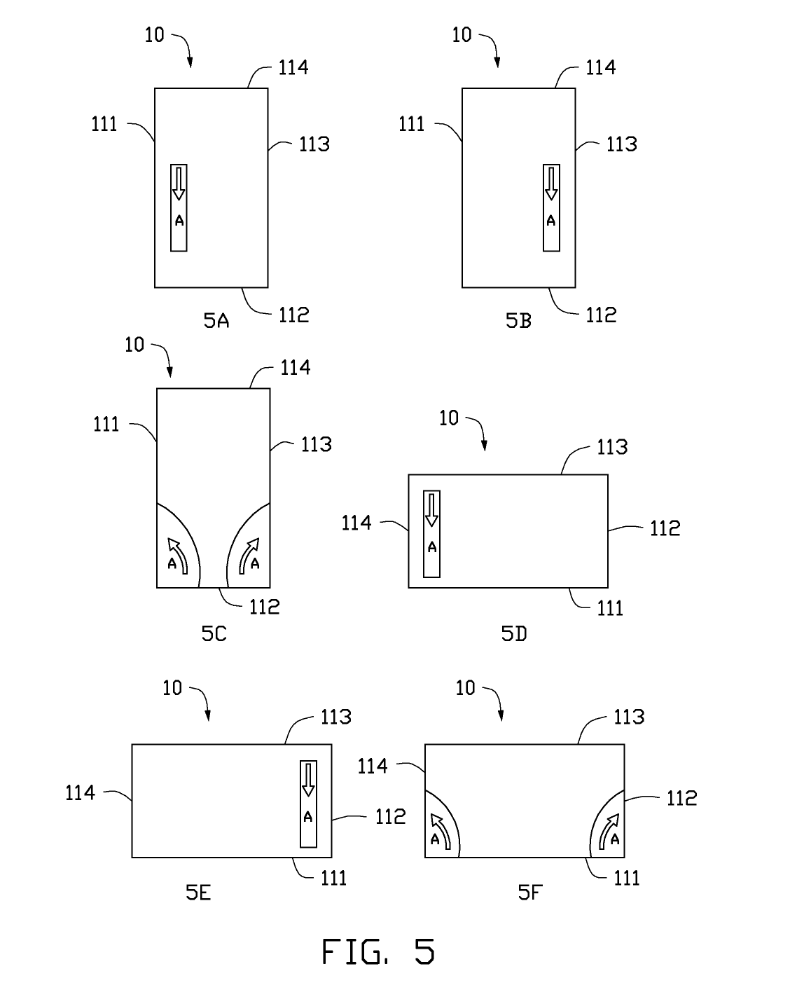

FIGS. 5A-5F illustrate operation interfaces of the touch device 10. The second corresponding relations between the holding information and the display locations of the at least one shortcut mark A are as follows.

Referring to FIG. 5A, when the holding information indicates that the touch device 10 is held in the portrait orientation by the left hand, the display control unit 23 controls the touch display screen 12 to display a shortcut mark A at a first area adjacent to the first side surface 111.

Referring to FIG. 5B, when the holding information represents that the touch device 10 is held in the portrait orientation by the right hand, the display control unit 23 controls the touch display screen 12 to display a shortcut mark A at a second area adjacent to the third side surface 113.

Referring to FIG. 5C, when the holding information represents that the touch device 10 is held in the portrait orientation by both the left and right hands, the display control unit 23 controls the touch display screen 12 to display two shortcut marks A. A first shortcut mark A is displayed at a third area adjacent to the first side surface 111 and the second side surface 112. A second shortcut mark A is displayed at a fourth area adjacent to the third side surface 113 and the second side surface 112.

Referring to FIG. 5D, when the holding information indicates that the touch device 10 is held in the landscape orientation by the left hand, the display control unit 23 controls the touch display screen 12 to display a shortcut mark A at a fifth area adjacent to the fourth side surface 114.

Referring to FIG. 5E, when the holding information represents that the touch device 10 is held in the landscape orientation by the right hand, the display control unit 23 controls the touch display screen 12 to display a shortcut mark A at a sixth area adjacent to the second side surface 112.

Referring to FIG. 5F, when the holding information represents that the touch device 10 is held in the landscape orientation by both the left and right hands, the display control unit 23 controls the touch display screen 12 to display two shortcut marks A. A first shortcut mark A is displayed at the third area adjacent to the first side surface 111 and the second side surface 112. A second shortcut mark A is displayed at a seventh area adjacent to the fourth side surface 114 and the first side surface 111.

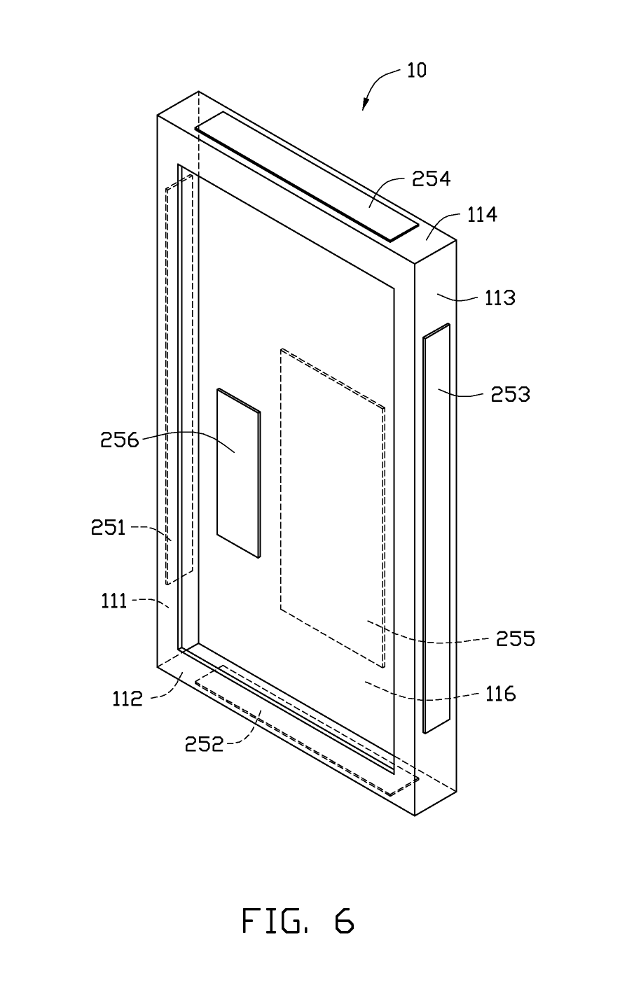

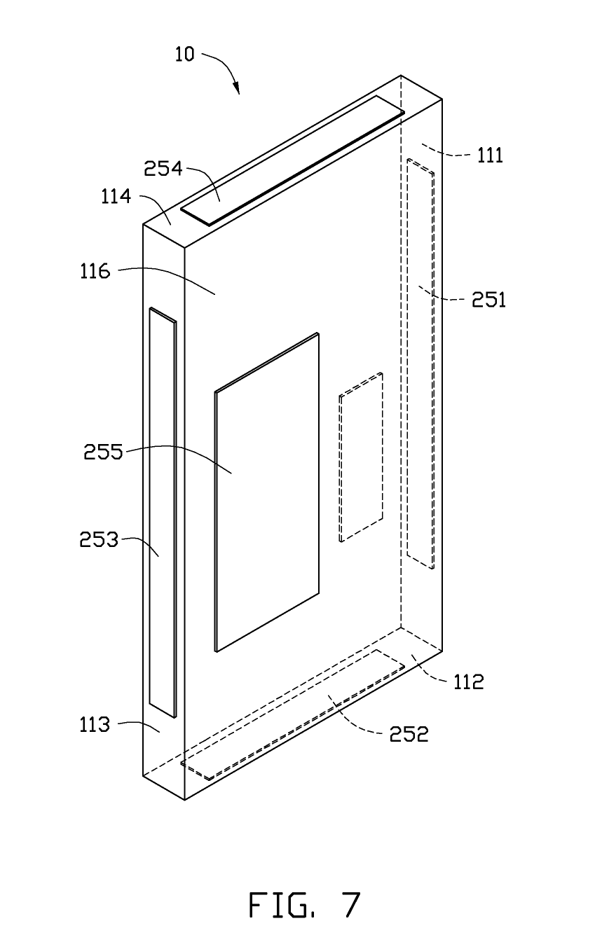

FIGS. 6-7 are schematic views illustrating locations of the first, second, third, fourth, fifth contact detection units 251, 252, 253, 254, 255 and the orientation detection unit 256 of FIG. 4. The first, second, third, and fourth contact detection units 251, 252, 253, 254 are located on the first, second, third, and fourth side surfaces 111, 112, 113, 114, respectively. The fifth contact detection unit 255 is located on the rear surface 116. Each of the first through fifth contact detection units 251-255 can detect multiple points of contact and output a number of first through fifth detecting signals corresponding to the multiple points of contact, respectively.

The orientation detection unit 256 is located between the enclosure 11 and the touch display screen 12, detects whether the touch device 10 is held in the portrait orientation or the landscape orientation, and selectively outputs a sixth detecting signal or a seventh detecting signal to the main control unit 21 based on the detection. When the orientation detection unit 256 detects that the touch device 10 is held in the portrait orientation, the orientation detection unit 256 outputs the sixth detecting signal to the main control unit 21. When the orientation detection unit 256 detects that the touch device 10 is held in the landscape orientation, the orientation detection unit 256 outputs the seventh detecting signal to the main control unit 21.

The first, second, third, fourth, and fifth contact detection units 251, 252, 253, 254, 255 can be resistive touch devices, capacitive touch devices, or other appropriate touch devices. The orientation detection unit 256 can be an accelerometer, a gravitation sensor, or other appropriate device for detecting the landscape and portrait orientations of the touch device 10.

Referring again to FIG. 5A, the main control unit 21 determines from the sixth detecting signal that the touch device 10 is held in the portrait orientation. The main control unit 21 further determines that a left hand of the user contacts more points of contact of the first side surface 111 than the third side surface 113. Thus, the display control unit 23 controls the touch display screen 12 to display the shortcut mark A at the first area adjacent to the first side surface 111. In one embodiment, if the main control unit 21 determines that opposite sides of the touch device 10 are contacted at a substantially equal number of points of contact, the display control unit 23 controls the touch display screen 12 to display the two shortcut marks A adjacent to the two opposite sides of the touch device 10 (as shown in FIGS. 5C and 5F). The main control unit 21 determines which orientation the touch device 10 is held in and which side of the touch device 10 is contacted at the most points of contact to display the shortcut mark A in the corresponding area.

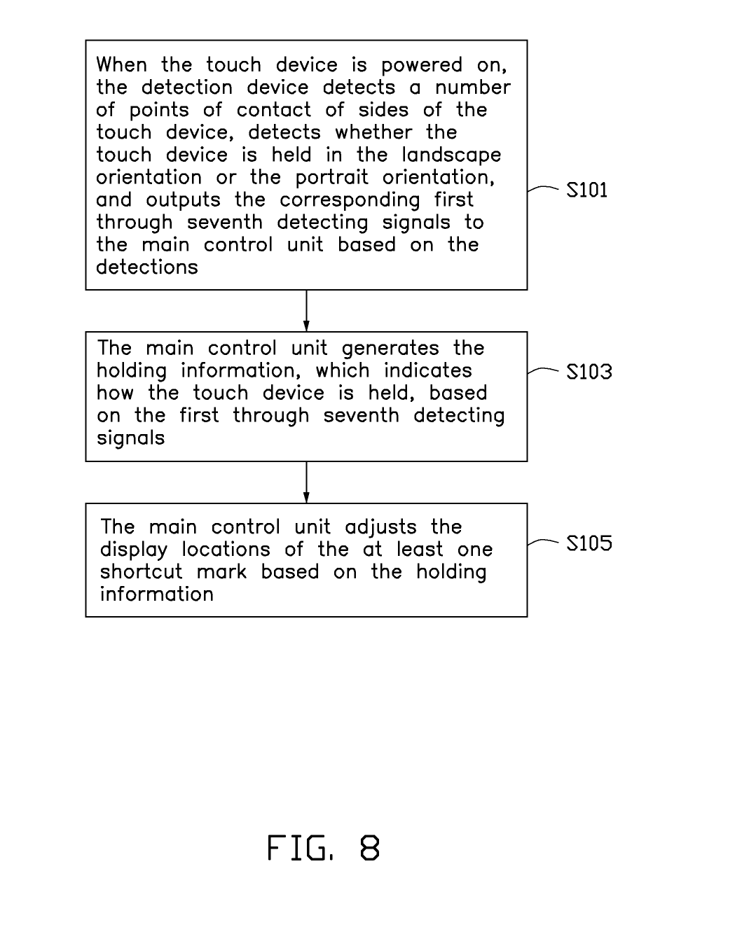

FIG. 8 is a flowchart of an embodiment of a control method illustrating an operation of the touch device 10. The control method is as follows.

In step S101, when the touch device 10 is powered on, the detection device 25 detects a number of points of contact of sides of the touch device 10, detects whether the touch device 10 is held in the landscape orientation or the portrait orientation, and outputs the corresponding first through seventh detecting signals to the main control unit 21 based on the detections.

In step S103, the main control unit 21 generates the holding information, which indicates how the touch device 10 is held, based on the first through seventh detecting signals.

In step S105, the main control unit 21 adjusts the display locations of the at least one shortcut mark A based on the holding information.

The touch device 10 dynamically adjusts the display locations of the at least one shortcut mark A according to the holding information making the touch device 10 of the present disclosure more convenient to use.

In alternative embodiments, the fifth contact detection unit 255 can be omitted, such that only the first through fourth contact detection units 251-254 are used to detect the number of points of contact contacted by the user.

It is believed that the present embodiments and their advantages will be understood from the foregoing description, and it will be apparent that various changes may be made thereto without departing from the spirit and scope of the present disclosure or sacrificing all of its material advantages.

What is claimed is:

1. A touch device, comprising:
a touch display screen displaying an operation interface that comprises at least one shortcut mark, and executing a corresponding function when the at least one shortcut mark is operated on;
a detection device detecting whether the touch device is held by a left hand, a right hand, or both hands of a user in a landscape orientation or a portrait orientation, and outputting detecting signals based on the detection of the detecting device; and
a main control unit connected to the touch display screen and the detection device, and adjusting a display location of the at least one shortcut mark based on the detecting signals.

2. The touch device of claim 1, wherein the main control unit generates holding information based on the detecting signals, and adjusting the display location of the at least one shortcut mark based on the holding information.

3. The touch device of claim 2, further comprising a data storage, wherein the data storage stores corresponding relations between the holding information and display locations of the at least one shortcut mark; the main control unit determines the display location of the at least one shortcut mark that is to be displayed from the data storage, based on the generated holding information, and adjusts the display location of the at least one shortcut mark based on a determination.

4. The touch device of claim 3, further comprising a substantially cuboid enclosure comprising a first side surface, a second side surface, a third side surface, a fourth side surface, a front surface, and a rear surface; wherein the first, second, third, and fourth side surfaces are connected to one another end-to-end; the first side surface faces the third side surface; the second side surface faces the fourth side surface; the rear surface faces the front surface; the touch display screen is received in the front surface.

5. The touch device of claim 4, wherein the detection device comprises a first contact detection unit, a second contact detection unit, a third contact detection unit, and a fourth contact detection unit; the first, second, third, and fourth contact detection units are respectively located on the first, second, third, and fourth side surfaces; the first, second, third, and fourth contact detection units detect whether the touch device is held by the left, right, or both hands of the user.

6. The touch device of claim 5, wherein the detection device further comprises an orientation detection unit located between the enclosure and the touch display screen; the orientation detection unit detects whether the touch device is held in a portrait orientation or a landscape orientation.

7. The touch device of claim 6, wherein when the main control unit determines that the touch device is held in the portrait orientation by the left hand, the main control unit controls the touch display screen to display the shortcut mark at a first area adjacent to the first side surface.

8. The touch device of claim 6, wherein when the main control unit determines that the touch device is held in the portrait orientation by the right hand, the main control unit controls the touch display screen to display the shortcut mark at a second area adjacent to the third side surface.

9. The touch device of claim 6, wherein when the main control unit determines that the touch device is held in the portrait orientation by the left and right hands of the user, the main control unit controls the touch display screen to display two shortcut marks, a first shortcut mark is displayed at a third area adjacent to the first side surface and the second side surface, and a second shortcut mark is displayed at a fourth area adjacent to the third side surface and the second side surface.

10. The touch device of claim 6, wherein when the main control unit determines that the touch device is held in the landscape orientation by the left hand, the main control unit controls the touch display screen to display the shortcut mark at a fifth area adjacent to the fourth side surface.

11. The touch device of claim 6, wherein when the main control unit determines that the touch device is held in the landscape orientation by the right hand, the main control unit controls the touch display screen to display the shortcut mark at a sixth area adjacent to the second side surface.

12. The touch device of claim 6, wherein when the main control unit determines that the touch device is held in the landscape orientation by the left and right hands of the user, the main control unit controls the touch display screen to display two shortcut marks, a first shortcut mark is displayed at the third area adjacent to the first side surface and the second side surface, and a second shortcut mark is displayed at a seventh area adjacent to the fourth side surface and the first side surface.

13. The touch device of claim 6, wherein the detection device further comprises a fifth contact unit located on the rear surface and detects points of contact on the rear surface.

14. A control method for a touch device, the touch display device comprising an operation interface, the operation interface comprising at least one shortcut mark, the control method comprising:
detecting a number of points of contact of sides of the touch device and determining whether the touch device is held by a left hand, a right hand, or both hands based on the number of points of contact of sides of the touch device detected;
detecting whether the touch device is held in a landscape orientation or a portrait orientation;
generating holding information indicating how the touch device is held; and
adjusting a display location of the at least one shortcut mark based on the holding information.
